(19) United States
(12) Patent Application Publication
(10) Pub. No.: US 2016/0120387 A1
(43) Pub. Date: May 5, 2016

(54) HARD SURFACE PREMOISTENED WIPES, CLEANING IMPLEMENTS AND METHODS THEREOF

(71) Applicant: The Procter & Gamble Company, Cincinnati, OH (US)

(72) Inventors: Geert Andre DELEERSNYDER, Wielsbeke (BE); Stefano SCIALLA, Rome (IT); Jessica Lea ELLIS, Cincinnati, OH (US)

(21) Appl. No.: 14/920,988

(22) Filed: Oct. 23, 2015

Related U.S. Application Data
(60) Provisional application No. 62/118,477, filed on Feb. 20, 2015.
(60) Provisional application No. 62/069,948, filed on Oct. 29, 2014.

(51) Int. Cl. A47L 13/17; C11D 1/75; B08B 3/10; C11D 17/00; C11D 17/04; B08B 1/00; C11D 1/83; C11D 1/14

(52) U.S. Cl. CPC A47L 13/17; C11D 1/83; C11D 1/75; C11D 1/143; C11D 17/0008; C11D 17/049; B08B 1/006; B08B 3/10

(57) ABSTRACT

A disposable premoistened wipe and cleaning implement and methods of cleaning a hard surface using a disposable premoistened wipe or cleaning implement. The disposable premoistened wipe comprises a cleaning composition and a substrate impregnated with the cleaning composition. The cleaning implement comprises a cleaning composition and a disposable dry cleaning sheet. The cleaning composition comprises an ethoxylated alkoxylated nonionic surfactant, an additional nonionic surfactant selected from the group consisting of: an alkyl ethoxylated alcohol, alkyl polyglycosides, amine oxide, and mixture thereof, and an anionic surfactant.

### FIELD OF THE INVENTION

The present invention relates to hard surface premoistened wipes, cleaning implements and methods thereof, and more particularly to wipes and cleaning implements that include cleaning composition comprising ethoxylated alkoxylated nonionic surfactants and their use in improving shine on hard surfaces, improving drying time and hence reducing slipperiness.

### BACKGROUND OF THE INVENTION

Liquid cleaning compositions for treating hard surfaces, such as, kitchen and bathroom surfaces, eyeglasses, and surfaces that require cleaning in industry for example surfaces of machinery or automobiles are known in the art. Such compositions can be used as such in a neat cleaning operation or in diluted form. Such compositions are often used in combination with conventional wiping products or more recently in combination with absorbent disposable cleaning pads.

Conventional wiping products are typically natural or synthetic sponges, soft or scouring pads, brushes, cloths, paper towels. Such wiping products can be used, as desired, in combination with cleaning implements comprising a handle for tough to reach areas or for the cleaning of floors, walls, or other large area surfaces either inside or outside the home, in office settings or in commercial or public establishments. Such devices can also have the wiping element combined or built into the handle such as sponge mops, string mops and strip mops.

Pre-moistened wipe cleaning products in the form of laminates are commercially available. One example is Swiffer Wet®, a tri-laminate wipe that comprises an aqueous composition impregnated on a point-bonded floor sheet, a cellulosic reservoir core and a spunbond attachment sheet.

Absorbent disposable cleaning pads represent a method of cleaning, geared toward achieving outstanding end result. These disposable pads are advantageous in that they not only loosen dirt, but also absorb more of the dirty solution as compared to conventional cleaning tools or pre-moistened wipes. As a result, surfaces are left with reduced residue and dry faster. The use of disposable pads comprising super-absorbent polymer, i.e., absorbent disposable cleaning pads are particularly advantageous in that the polymer improves the mileage, longevity, reuse-ability and economic value of the pads. Such pads are disclosed in U.S. Pat. Nos. 6,048,123; 6,003,191; 5,960,508; and 6,101,661; incorporated herein by reference. The pads can be used as stand-alone products or in combination with an implement comprising a handle, particularly for the cleaning of floor surfaces. An example of such a product is currently sold by Procter and Gamble under “Swiffer WETJET®”.

A commonly known problem in treating hard surfaces is the formation of films and/or streaks on surfaces treated therewith. Indeed, after the treatment of a hard surface with a liquid cleaning composition, the formation of visible residues (streaks) and/or shine reducing films after drying can often be observed. Moreover, long drying times can result in damage to delicate surfaces, such as spotting and rusting of steel surfaces.

Hence, a need remains for a composition that can be used with a wipe or cleaning implements which provides improved shine. In addition, a need remains for a hard surface cleaning composition that can be used with a wipe or cleaning implements which is suitable for cleaning a variety of surfaces, and results in surfaces which are quicker drying.

### SUMMARY OF THE INVENTION

The present application relates to a disposable premoistened wipe for cleaning hard surfaces comprising a substrate and a cleaning composition. The cleaning composition comprising an ethoxylated alkoxylated nonionic surfactant, an additional nonionic surfactant selected from the group consisting of: an alkyl ethoxylated alcohol, alkyl polyglycosides, amine oxide, and mixture thereof, and an anionic surfactant. The substrate is impregnated with the cleaning composition. The present application also relates to methods of cleaning hard surfaces comprising contacting the hard surface with such the disposable premoistened wipe.

The present application also relates to a cleaning implement for cleaning hard surfaces comprising a disposable dry cleaning wipe and a reservoir filled with a cleaning composition. The cleaning composition comprising an ethoxylated alkoxylated nonionic surfactant, an additional non-ionic surfactant selected from the group consisting of: an alkyl ethoxylated alcohol, alkyl polyglycosides, amine oxide, and mixture thereof, and an anionic surfactant. The present application also relates to methods of cleaning hard surfaces with the cleaning implement according comprising spraying the hard surface with the cleaning composition and removing the cleaning composition from the hard surface with the disposable dry cleaning wipe.

### DETAILED DESCRIPTION OF THE INVENTION

The disposable premoistened wipes, cleaning implements and methods thereof of the present application comprise an ethoxylated alkoxylated nonionic surfactant and an additional nonionic surfactant in combination with an anionic surfactant; provide improved shine, even when cleaning especially dirty floors. In addition, they are effective at cleaning a variety of surfaces. Moreover, since surfaces which are treated with the hard surface cleaning composition of the present invention dry more quickly, there is less risk of slips and other accidental falls.

As defined herein, “essentially free of” a component means that no amount of that component is deliberately incorporated into the respective premix, or composition. Preferably, “essentially free of” a component means that no amount of that component is present in the respective premix, or composition.

As used herein, “isotropic” means a clear mixture, having little or no visible haziness, phase separation and/or dispersed particles, and having a uniform transparent appearance.

As defined herein, “stable” means that no visible phase separation is observed for a premix kept at 25° C. for a period of at least two weeks, or at least four weeks, or greater than a month or greater than four months, as measured using the Floc Formation Test, described in USPA 2008/0263780 A1.

All percentages, ratios and proportions used herein are by weight percent of the premix, unless otherwise specified. All average values are calculated “by weight” of the premix, unless otherwise expressly indicated.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Liquid Hard Surface Cleaning Compositions:

By “liquid hard surface cleaning composition”, it is meant herein a liquid composition for cleaning hard surfaces found in households, especially domestic households. Surfaces to be cleaned include kitchens and bathrooms, e.g., floors, walls, tiles, windows, cupboards, sinks, showers, shower plastified curtains, wash basins, WCs, fixtures and fittings and the like made of different materials like ceramic, vinyl, no-wax vinyl, linoleum, melamine, glass, steel, kitchen work surfaces, any plastics, plastified wood, metal or any painted or varnished or sealed surface and the like. Household hard surfaces also include household appliances including, but not limited to refrigerators, freezers, washing machines, automatic dryers, ovens, microwave ovens, dishwashers and so on. Such hard surfaces may be found both in private households as well as in commercial, institutional and industrial environments.

In a preferred embodiment, the liquid compositions herein are aqueous compositions. Therefore, they may comprise from 87% to 99.5% by weight of the total composition of water, preferably from 93% to 99.5% and more preferably from 97% to 99.5%.

The compositions of the present invention preferably have a viscosity from 0.1 cps to 650 cps, more preferably of from 0.1 cps to 550 cps, more preferably from 0.5 cps to 450 cps, even more preferably from 1.0 cps to 300 cps and most preferably from 1.0 cps to 250 cps when measured at 20° C. with a AD1000 Advanced Rheometer from Atlas® shear rate 10 s⁻¹ with a coned spindle of 40 mm with a cone angle 2° and a truncation of ±60 μm.

The pH is preferably from 5.0 to 12, more preferably from 5.0 to 11.5, even more preferably from 6.0 to 11.3, most preferably 6.0 to 11. It is believed that the greasy soil and particulate greasy soil cleaning performance is further improved at alkaline pH ranges, while the removal of particulate is enhanced at acidic pH. Accordingly, the compositions herein may further comprise an acid or base to adjust pH as appropriate.

A suitable acid for use herein is an organic and/or an inorganic acid. A preferred organic acid for use herein has a pKa of less than 6. A suitable organic acid is selected from the group consisting of: citric acid, lactic acid, glycolic acid, succinic acid, glutaric acid and adipic acid and mixtures thereof. A suitable inorganic acid can be selected from the group consisting of: hydrochloric acid, sulphuric acid, phosphoric acid and mixtures thereof.

A typical level of such acids, when present, is from 0.01% to 2.0% by weight of the total composition, preferably from 0.04% to 1.5% and more preferably from 0.05% to 1.0%.

A suitable base to be used herein is an organic and/or inorganic base. Suitable bases for use herein are the caustic alkalis, such as sodium hydroxide, potassium hydroxide and/or lithium hydroxide, and/or the alkali metal oxides such, as sodium and/or potassium oxide or mixtures thereof. A preferred base is a caustic alkali, more preferably sodium hydroxide and/or potassium hydroxide.

Other suitable bases include ammonia, ammonium carbonate, K₂CO₃, Na₂CO₃ and alkanolamines (such as monoethanolamine, triethanolamine, aminomethylpropanol, and mixtures thereof).

Typical levels of such bases, when present, are from 0.01% to 2.0% by weight of the total composition, preferably from 0.05% to 1.5% and more preferably from 0.1% to 1.0%.

The total amount of surfactant, excluding the ethoxylated alkoxylated nonionic surfactant, is preferably from 0.002% to 10%, more preferably from 0.01% to 5% and most preferably from 0.01% to 3% by weight of the composition.

Preferably, the liquid hard surface cleaner has a turbidity of from 5 NTU to less than 3000 NTU, preferably less than 1000 NTU, more preferably less than 500 NTU and most preferably less than 100 NTU.

### Ethoxylated Alkoxylated Nonionic Surfactant:

The liquid hard surface cleaning composition comprises an ethoxylated alkoxylated nonionic surfactant. Preferably, the liquid hard surface cleaning composition comprises the ethoxylated alkoxylated nonionic surfactant at a level of from 0.002% to 5%, more preferably from 0.003% to 3%, most preferably from 0.005% to 1% of the composition. The ethoxylated alkoxylated nonionic surfactant is preferably selected from the group consisting of: esterified alkyl alkoxylated surfactant; alkyl ethoxy alkoxy alcohol, wherein the alkoxy part of the molecule is preferably propoxy, or butoxy, or propoxy-butoxy; polyoxyalkylene block copolymers, and mixtures thereof.

The preferred ethoxylated alkoxylated nonionic surfactant is an esterified alkyl alkoxylated surfactant of general formula (I):

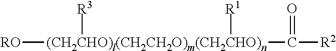

where R is a branched or unbranched alkyl radical having 8 to 16 carbon atoms, preferably from 10 to 16 and more preferably from 12 to 15; R³, R¹ independently of one another, are hydrogen or a branched or unbranched alkyl radical having 1 to 5 carbon atoms; preferably R³ and R¹ are hydrogen R² is an unbranched alkyl radical having 5 to 17 carbon atoms; preferably from 6 to 14 carbon atoms 1, n independently of one another, are a number from 1 to 5 and m is a number from 8 to 50; and preferably, the weight average molecular weight of the ethoxylated alkoxylated nonionic surfactant of formula (I) is from 950 to 2300 g/mol, more preferably from 1200 to 1900 g/mol.

R is preferably from 12 to 15, preferably 13 carbon atoms. R³ and R¹ are preferably hydrogen. 1 is preferably 5. n is preferably 1. m is preferably from 13 to 35, more preferably 15 to 25, most preferably 22. R² is preferably from 6 to 14 carbon atoms.

The hard surface cleaning composition of the invention provides especially good shine when the esterified alkyl akoxylated surfactant is as follows: R has from 12 to 15, preferably 13 carbon atoms, R³ is hydrogen, R¹ is hydrogen, 1 is 5, n is 1, m is from 15 to 25, preferably 22 and R² has from 6 to 14 carbon atoms and the alcohol ethoxylated has an aliphatic alcohol chain containing from 10 to 14, more preferably 13 carbon atoms and from 5 to 8, more preferably 7 molecules of ethylene oxide.

Another preferred ethoxylated alkoxylated nonionic surfactant is an alkyl ethoxy alkoxy alcohol, preferably wherein the alkoxy part of the molecule is propoxy, or butoxy, or propoxy-butoxy. More preferred alkyl ethoxy alkoxy alcohols are of formula (II):

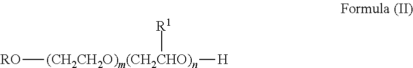

wherein:
R is a branched or unbranched alkyl radical having 8 to 16 carbon atoms;
R¹ is a branched or unbranched alkyl radical having 1 to 5 carbon atoms;
n is from 1 to 10; and m is from 6 to 35.

R is preferably from 12 to 15, preferably 13 carbon atoms. R¹ is preferably a branched alkyl radical having from 1 to 2 carbon atoms. n is preferably 1 to 5. m is preferably from 8 to 25. Preferably, the weight average molecular weight of the ethoxylated alkoxylated nonionic surfactant of formula (II) is from 500 to 2000 g/mol, more preferably from 600 to 1700 g/mol, most preferably 800 to 1500 g/mol.

The ethoxylated alkoxylated nonionic surfactant can be a polyoxyalkylene copolymer. The polyoxyalkylene copolymer can be a block-heteric ethoxylated alkoxylated nonionic surfactant, though block-block surfactants are preferred. Suitable polyoxyalkylene block copolymers include ethylene oxide/propylene oxide block polymers, of formula (III):

(EO)ₓ(PO)_{y}(EO)ₓ, or

(PO)ₓ(EO)_{y}(PO)ₓ

wherein EO represents an ethylene oxide unit, PO represents a propylene oxide unit, and x and y are numbers detailing the average number of moles ethylene oxide and propylene oxide in each mole of product. Such materials tend to have higher molecular weights than most non-ionic surfactants, and as such can range between 1000 and 30000 g/mol, although the molecular weight should be above 2200 and preferably below 13000 to be in accordance with the invention. A preferred range for the molecular weight of the polymeric non-ionic surfactant is from 2400 to 11500 Daltons. BASF (Mount Olive, N.J.) manufactures a suitable set of derivatives and markets them under the Pluronic trademarks. Examples of these are Pluronic (trademark) F77, L62 and F88 which have the molecular weight of 6600, 2450 and 11400 g/mol respectively. An especially preferred example of a useful polymeric non-ionic surfactant is Pluronic (trademark) F77.

Another preferred ethoxylated alkoxylated nonionic surfactant is a hydroxy mixed ether corresponding to the general formula:

R¹O[CH₂CH₂O]ₓCH₂CH(OH)R²

in which R¹ is a linear or branched alkyl and/or alkenyl group containing 4 to 22 carbon atoms, R² is a linear or branched alkyl and/or alkenyl group containing 2 to 22 carbon atoms and x=20 to 80.

Other suitable ethoxylated alkoxylated nonionic surfactants are described in Chapter 7 of Surfactant Science and Technology, Third Edition, Wiley Press, ISBN 978-O-471-68024-6. The ethoxylated alkoxylated nonionic surfactant preferably provides a wetting effect of from 15 to 350, more preferably from 60 to 200, even more preferably from 75 to 150. The wetting effect is measured according to EN 1772, using 1 g/l of the ethoxylated alkoxylated nonionic surfactant in distilled water, at 23° C., with 2 g soda/1. Preferred ethoxylated alkoxylated nonionic surfactants include those sold by BASF under the “Plurafac” trademark, especially Plurafac LF 301 (wetting effect of 90 s), LF 401 (wetting effect of 115 s), LF 405 (wetting effect of 100 s), and LF 7319 (wetting effect of 100 s). It is believed that that the combination of a ethoxylated alkoxylated nonionic surfactant, especially a ethoxylated alkoxylated nonionic surfactant having the aforementioned wetting effect, with the additional nonionic surfactant, results in beading of the residual wash water on the hard surface, after cleaning, and hence, improved removal of the residual dirt during subsequent wiping. Moreover, the resultant beading results in faster drying time and hence less slipperiness.

### Additional Nonionic Surfactant

The liquid hard surface cleaning composition comprises an additional nonionic surfactant. The additional nonionic surfactant is selected from the group consisting of: alkoxylated nonionic surfactants, alkyl polyglycosides, amine oxides, and mixture thereof. Typically, the liquid hard surface cleaning composition may comprise from 0.005% to 5% by weight of the total composition of said additional nonionic surfactant, preferably from 0.01% to 3%, more preferably from 0.04% to 1% and most preferably from 0.02% to 1%.

It has been discovered that the combination of the ethoxylated alkoxylated nonionic surfactant and the nonionic surfactant result in improved shine, without a loss of cleaning efficacy. The improvement in shine is particularly noticeable when the ethoxylated alkoxylated nonionic surfactant and the additional nonionic surfactant are present in a weight ratio of from 0.03 to 0.4, preferably from 0.035 to 0.2 and more preferably from 0.04 to 0.09 especially when the ethoxylated alkoxylated nonionic surfactant is an esterified alkyl alkoxylated surfactant of formula I.

All ratios are calculated as a weight/weight level, unless otherwise specified.

The hard surface cleaning composition can comprise from 0.01% to 10%, preferably from 0.02% to 6%, more preferably from 0.03% to 5% and most preferably from 0.04% to 4% of the composition of alkoxylated alcohol, preferably ethoxylated alcohol.

Suitable alkoxylated nonionic surfactants include primary C₆-C₁₆ alcohol polyglycol ether i.e. ethoxylated alcohols having 6 to 16 carbon atoms in the alkyl moiety and 4 to 30 ethylene oxide (EO) units. When referred to for example C₉₋₁₄ it is meant average carbons and alternative reference to for example EO8 is meant average ethylene oxide units.

Suitable alkoxylated nonionic surfactants are according to the formula RO-(A)ₙH, wherein: R is a C₆ to C₁₈, preferably a C₈ to C₁₆, more preferably a C₈ to C₁₂ alkyl chain, or a C₆ to C₂₈ alkyl benzene chain; A is an ethoxy or propoxy or butoxy unit, and wherein n is from 1 to 30, preferably from 1 to 15 and, more preferably from 4 to 12 even more preferably from 5 to 10. Preferred R chains for use herein are the C₈ to C₂₂ alkyl chains. Even more preferred R chains for use herein are the C₉ to C₁₂ alkyl chains. R can be linear or branched alkyl chain.

Suitable ethoxylated nonionic surfactants for use herein are Dobanol® 91-2.5 (HLB=8.1; R is a mixture of C₉ and C₁₁ alkyl chains, n is 2.5), Dobanol® 91-10 (HLB=14.2; R is a mixture of C₉ to C₁₁ alkyl chains, n is 10), Dobanol® 91-12 (HLB=14.5; R is a mixture of C₉ to C₁₁ alkyl chains, n is 12), Greenbentine DE80 (HLB=13.8, 98 wt % C10 linear alkyl chain, n is 8), Marlipal 10-8 (HLB=13.8, R is a C10 linear alkyl chain, n is 8), Lialethl® 11-5 (R is a C₁₁ alkyl chain, n is 5), Isalchem® 11-5 (R is a mixture of linear and branched C11 alkyl chain, n is 5), Lialethl® 11-21 (R is a mixture of linear and branched C₁₁ alkyl chain, n is 21), Isalchem® 11-21 (R is a C₁₁ branched alkyl chain, n is 21), Empilan® KBE21 (R is a mixture of C₁₂ and C₁₄ alkyl chains, n is 21) or mixtures thereof. Preferred herein are Dobanol® 91-5, Neodol® 11-5, Lialethl® 11-21 Lialethl® 11-5 Isalchem® 11-5 Isalchem® 11-21 Dobanol® 91-8, or Dobanol® 91-10, or Dobanol® 91-12, or mixtures thereof. These Dobanol®/Neodol® surfactants are commercially available from SHELL. These Lutensol® surfactants are commercially available from BASF and these Tergitol® surfactants are commercially available from Dow Chemicals. Suitable chemical processes for preparing the alkoxylated nonionic surfactants for use herein include condensation of corresponding alcohols with alkylene oxide, in the desired proportions. Such processes are well known to the person skilled in the art and have been extensively described in the art, including the OXO process and various derivatives thereof. Suitable alkoxylated fatty alcohol nonionic surfactants, produced using the OXO process, have been marketed under the tradename NEODOL® by the Shell Chemical Company. Alternatively, suitable alkoxylated nonionic surfactants can be prepared by other processes such as the Ziegler process, in addition to derivatives of the OXO or Ziegler processes.

Preferably, said alkoxylated nonionic surfactant is a C₉₋₁₁ EO5 alkylethoxylate, C₁₂₋₁₄ EO5 alkylethoxylate, a C₁₁ EO5 alkylethoxylate, C₁₂₋₁₄ EO21 alkylethoxylate, or a C₉₋₁₁ EO8 alkylethoxylate or a mixture thereof. Most preferably, said alkoxylated nonionic surfactant is a C₁₁ EO5 alkylethoxylate or a C₉₋₁₁ EO8 alkylethoxylate or a mixture thereof.

Alkyl polyglycosides are biodegradable nonionic surfactants which are well known in the art. Suitable alkyl polyglycosides can have the general formula CₙH₂ₙ₊₁O(C₆H₁₀O₅)ₓH wherein n is preferably from 9 to 16, more preferably 11 to 14, and x is preferably from 1 to 2, more preferably 1.3 to 1.6. Such alkyl polyglycosides provide a good balance between anti-foam activity and detergency. Alkyl polyglycoside surfactants are commercially available in a large variety. An example of a very suitable alkyl poly glycoside product is Planteren APG 600, which is essentially an aqueous dispersion of alkyl polyglycosides wherein n is about 13 and x is about 1.4.

Suitable amine oxide surfactants include: R₁R₂R₃NO wherein each of R₁, R₂ and R₃ is independently a saturated or unsaturated, substituted or unsubstituted, linear or branched hydrocarbon chain having from 10 to 30 carbon atoms. Preferred amine oxide surfactants are amine oxides having the following formula: R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain. Preferably, the liquid hard surface cleaning composition comprises from 0.002% to 5%, preferably from 0.003% to 3%, more preferably from 0.005% to 1% and most preferably from 0.02% to 0.06% of the composition of amine oxide surfactant.

A highly preferred amine oxide is C₁₂-C₁₄ dimethyl amine oxide, commercially available from Albright & Wilson, C₁₂-C₁₄ amine oxides commercially available under the trade name Genaminox® LA from Clariant or AROMOX® DMC from AKZO Nobel.

The additional nonionic surfactant is preferably a low molecular weight nonionic surfactant, having a molecular weight of less than 950 g/mol, more preferably less than 500 g/mol.

### Anionic Surfactant:

The liquid hard surface cleaning composition comprises an anionic surfactant. Preferably, the anionic surfactant is selected from the group consisting of: an alkyl sulphate, an alkyl alkoxylated sulphate, a sulphonic acid or sulphonate surfactant, and mixtures thereof. The liquid hard surface cleaning composition can comprise from 0.005 wt % to 5 wt %, preferably from 0.01 wt % to 3 wt %, and most preferably from 0.02 wt % to 1 wt % of anionic surfactant.

Suitable alkyl sulphates for use herein include water-soluble salts or acids of the formula ROSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphates include C₁₂₋₁₄ alkyl sulphate like EMPICOL® 0298/, EMPICOL® 0298/F or EMPICOL® XLB commercially available from Huntsman. By “linear alkyl sulphate” it is meant herein a non-substituted alkyl sulphate wherein the linear alkyl chain comprises from 6 to 16 carbon atoms, preferably from 8 to 14 carbon atoms, and more preferably from 10 to 14 carbon atoms, and wherein this alkyl chain is sulphated at one terminus. Suitable sulphonated anionic surfactants for use herein are all those commonly known by those skilled in the art. Preferably, the sulphonated anionic surfactants for use herein are selected from the group consisting of: alkyl sulphonates; alkyl aryl sulphonates; naphthalene sulphonates; alkyl alkoxylated sulphonates; and C₆-C₁₆ alkyl alkoxylated linear or branched diphenyl oxide disulphonates; and mixtures thereof.

Suitable alkyl sulphonates for use herein include water-soluble salts or acids of the formula RSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₁₈ linear or branched saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Particularly suitable linear alkyl sulphonates include C₁₂-C₁₆ paraffin sulphonate like Hostapur® SAS commercially available from Clariant. Particularly preferred alkyl aryl sulphonates are alkyl benzene sulphonates commercially available under trade name Nansa® available from Huntsman.

By “linear alkyl sulphonate” it is meant herein a non-substituted alkyl sulphonate wherein the alkyl chain comprises from 6 to 18 carbon atoms, preferably from 8 to 16 carbon atoms, and more preferably from 10 to 16 carbon atoms, and wherein this alkyl chain is sulphonated at one terminus.

Suitable alkoxylated sulphonate surfactants for use herein are according to the formula R(A)ₘSO₃M, wherein R is an unsubstituted C₆-C₁₈ alkyl, hydroxyalkyl or alkyl aryl group, having a linear or branched C₆-C₁₈ alkyl component, preferably a C₈-C₁₆ alkyl or hydroxyalkyl, more preferably C₁₂-C₁₆ alkyl or hydroxyalkyl, and A is an ethoxy or propoxy or butoxy unit, and m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like.

Exemplary surfactants are C₁₂-C₁₈ alkyl polyethoxylate (1.0) sulphonate (C₁₂-C₁₈E(1.0)SM), C₁₂-C₁₈ alkyl polyethoxylate (2.25) sulphonate (C₁₂-C₁₈E(2.25)SM), C₁₂-C₁₈ alkyl polyethoxylate (3.0) sulphonate (C₁₂-C₁₈E(3.0)SM), and C₁₂-C₁₈ alkyl polyethoxylate (4.0) sulphonate (C₁₂-C₁₈E(4.0)SM), wherein M is conveniently selected from sodium and potassium. Particularly suitable alkoxylated sulphonates include alkyl aryl polyether sulphonates like Triton X-200® commercially available from Dow Chemical.

Preferably said sulphated or sulphonated anionic surfactant for use herein is selected from the group consisting of alkyl sulphates (AS) preferably C₁₂, C₁₃, C₁₄ and C₁₅ AS, sodium linear alkyl sulphonate (NaLAS), sodium paraffin sulphonate NaPC₁₂₋₁₆S, and mixtures thereof. Most preferably sulphated or sulphonated anionic surfactant for use herein is selected from the group consisting of alkyl sulphates (AS) preferably, C₁₂, C₁₃, C₁₄ and C₁₅ AS, sodium linear alkyl sulphonate (NaLAS), sodium paraffin sulphonate NaPC₁₂₋₁₆S and mixtures thereof.

Typically, the liquid composition herein may comprise from 0.005% to 5% by weight of the total composition of said sulphated or sulphonated anionic surfactant, preferably from 0.01% to 3%, more preferably from 0.02% to 1% and most preferably from 0.02% to 0.06%.

### Additional Surfactant:

The hard surface cleaning composition may comprise up to 5% by weight of an additional surfactant, preferably selected from: an amphoteric, zwitterionic, and mixtures thereof. More preferably, the hard surface cleaning composition can comprise from 0.005% to 5%, or from 0.01% to 3%, or from 0.02% to 1% by weight of the additional surfactant.

Suitable zwitterionic surfactants typically contain both cationic and anionic groups in substantially equivalent proportions so as to be electrically neutral at the pH of use. The typical cationic group is a quaternary ammonium group, other positively charged groups like phosphonium, imidazolium and sulfonium groups can be used. The typical anionic hydrophilic groups are carboxylates and sulfonates, although other groups like sulfates, phosphonates, and the like can be used.

Some common examples of zwitterionic surfactants (such as betaine/sulphobetaine surfacants) are described in U.S. Pat. Nos. 2,082,275, 2,702,279 and 2,255,082. For example Coconut dimethyl betaine is commercially available from Seppic under the trade name of Amonyl 265®. Lauryl betaine is commercially available from Albright & Wilson under the trade name Empigen BB/L®. A further example of betaine is Lauryl-imminodipropionate commercially available from Rhodia under the trade name Mirataine H2C-HA®.

Sulfobetaine surfactants are particularly preferred, since they can improve soap scum cleaning. Examples of suitable sulfobetaine surfactants include tallow bis(hydroxyethyl) sulphobetaine, cocoamido propyl hydroxy sulphobetaines which are commercially available from Rhodia and Witco, under the trade name of Mirataine CBS® and ReWoteric AM CAS 15® respectively.

Amphoteric surfactants can be either cationic or anionic depending upon the pH of the composition. Suitable amphoteric surfactants include dodecylbeta-alanine, N-alkyltaurines such as the one prepared by reacting dodecylamine with sodium isethionate, as taught in U.S. Pat. No. 2,658,072, N-higher alkylaspartic acids such as those taught in U.S. Pat. No. 2,438,091, and the products sold under the trade name “Miranol”, as described in U.S. Pat. No. 2,528,378. Other suitable additional surfactants can be found in McCutcheon's Detergents and Emulsifers, North American Ed. 1980.

### Hydrophile-Lipophile Balance (HLB):

The surfactants of the liquid hard surface cleaning composition, excluding the ethoxylated alkoxylated nonionic surfactant, preferably have an overall hydrophile-lipophile balance (HLB) of from 6 to 36, preferably from 8 to 26, more preferably from 10 to 15. The hydrophile-lipophile balance (HLB) is a method for quantifying the potential surface activity of the surfactant system, based on its molecular constitution, and is described in more detail in section 9.7.1 of Surfactant Science and Technology, Third Edition, Wiley Press, ISBN 978-O-471-68024-6.

Particularly improved shine, in combination with good cleaning, is achieved when a surfactant system, having the above described HLB, is combined with the ethoxylated alkoxylated nonionic surfactant which provides the desired wetting effect. Hence, in a particularly preferred embodiment, the hard surface cleaning composition comprises: from 0.005% to 1.00% of a ethoxylated alkoxylated nonionic surfactant selected from esterified alkyl alkoxylated surfactant of formula (I); from 0.04% to 4% of ethoxylated alcohols from 0.02% to 1% of amine oxide, and from 0.02% to 1% of anionic surfactant.

### Optional Ingredients:

Thickener: The liquid hard surface cleaning composition can comprise a thickener. An increased viscosity, especially low shear viscosity, provides longer contact time and therefore improved penetration of greasy soil and/or particulated greasy soil to improve cleaning effectiveness, especially when applied neat to the surface to be treated. Moreover, a high low shear viscosity improves the phase stability of the liquid cleaning composition, and especially improves the stability of the ethoxylated alkoxylated nonionic surfactant in compositions in the liquid hard surface cleaning composition. Hence, preferably, the liquid hard surface cleaning composition, comprising a thickener, has a viscosity of from 1 cps to 650 cps, more preferably of from 0.1 cps to 550 cps, more preferably from 0.5 cps to 450 cps, even more preferably from 1.0 cps to 300 cps and most preferably from 1.0 cps to 250 cps when measured at 20° C. with a AD1000 Advanced Rheometer from Atlas® shear rate 10 s⁻¹ with a coned spindle of 40 mm with a cone angle 2° and a truncation of ±60 p.m.

Suitable thickeners include polyacrylate based polymers, preferably hydrophobically modified polyacrylate polymers; hydroxyl ethyl cellulose, preferably hydrophobically modified hydroxyl ethyl cellulose, xanthan gum, hydrogenated castor oil (HCO) and mixtures thereof.

Preferred thickeners are polyacrylate based polymers, preferably hydrophobically modified polyacrylate polymers. Preferably a water soluble copolymer based on main monomers acrylic acid, acrylic acid esters, vinyl acetate, methacrylic acid, acrylonitrile and mixtures thereof, more preferably copolymer is based on methacrylic acid and acrylic acid esters having appearance of milky, low viscous dispersion. Most preferred hydrologically modified polyacrylate polymer is Rheovis® AT 120, which is commercially available from BASF.

Other suitable thickeners are hydroxethylcelluloses (HM-HEC) preferably hydrophobically modified hydroxyethylcellulose. Suitable hydroxethylcelluloses (HM-HEC) are commercially available from Aqualon/Hercules under the product name Polysurf 76® and W301 from 3V Sigma.

Xanthan gum is one suitable thickener used herein. Xanthan gum is a polysaccharide commonly used rheoligy modifier and stabilizer. Xanthan gum is produced by fermentation of glucose or sucroce by the xanthomonas campestris bacterium. Suitable Xanthan gum is commercially available under tradename Kelzan T® from CP Kelco.

Hydrogenated castor oil is one suitable thickener used herein. Suitable hydrogenated castor oil is available under trade name THIXCIN R from Elementis.

The most preferred thickener used herein is a modified methacrylic acid/acrylic acid copolymer Rheovis® AT 120, which is commercially available from BASF.

When used, the liquid hard surface cleaning composition comprises from 0.002% to 2% by weight of the total composition of said thickener, preferably from 0.002% to 1%, more preferably from 0.002% to 0.5% and most preferably from 0.002% to 0.1%.

Chelating agent: The liquid hard surface cleaning composition can comprise a chelating agent or crystal growth inhibitor. Suitable chelating agents, in combination with the surfactant system, improve the shine benefit. Chelating agent can be incorporated into the compositions in amounts ranging from 0.002% to 3% by weight of the total composition, preferably from 0.002% to 2%, more preferably from 0.002% to 1% and most preferably from 0.002% to 0.5%.

Suitable phosphonate chelating agents include ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agent to be used herein is diethylene triamine penta methylene phosphonate (DTPMP). Such phosphonate chelating agents are commercially available from Monsanto under the trade name DEQUEST®.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename (S,S)EDDS® from Palmer Research Laboratories. Most preferred biodegradable chelating agent is L-glutamic acid N,N-diacetic acid (GLDA) commercially available under tradename Dissolvine 47S from Akzo Nobel.

Suitable amino carboxylates for use herein include ethylene diamine tetra acetates, diethylene triamine pentaacetates, diethylene triamine pentaacetate (DTPA), N-hydroxyethylethylenediamine triacetates, nitrilotriacetates, ethylenediamine tetrapropionates, triethylenetetraaminehexa-acetates, ethanoldiglycines, and methyl glycine diacetic acid (MGDA), both in their acid form, or in their alkali metal, ammonium, and substituted ammonium salt forms. Particularly suitable amino carboxylate to be used herein is propylene diamine tetracetic acid (PDTA) which is, for instance, commercially available from BASF under the trade name Trilon FS® and methyl glycine di-acetic acid (MGDA). Most preferred aminocarboxylate used herein is diethylene triamine pentaacetate (DTPA) from BASF. Further carboxylate chelating agents for use herein include salicylic acid, aspartic acid, glutamic acid, glycine, malonic acid or mixtures thereof.

Additional polymers: The liquid hard surface cleaning composition may comprise an additional polymer. It has been found that the presence of a specific polymer as described herein, when present, allows further improving the grease removal performance of the liquid composition due to the specific sudsing/foaming characteristics they provide to the composition. Suitable polymers for use herein are disclosed in co-pending EP patent application EP2272942 (09164872.5) and granted European patent EP2025743 (07113156.9).

The polymer can be selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/polyacrylic acid copolymer (PVP-AA); a polyvinylpyrrolidone/vinylacetate copolymer (PVP-VA); a polyacrylic polymer or polyacrylicmaleic copolymer; and a polyacrylic or polyacrylic maleic phosphono end group copolymer; and mixtures thereof.

Typically, the liquid hard surface cleaning composition may comprise from 0.005% to 2% by weight of the total composition of said polymer, preferably from 0.01% to 1.5%, more preferably from 0.01% to 1% and most preferably from 0.01% to 0.5%.

Fatty acid: The liquid hard surface cleaning composition may comprise a fatty acid as a highly preferred optional ingredient, particularly as suds suppressors. Fatty acids are desired herein as they reduce the sudsing of the liquid composition when the composition is rinsed off the surface to which it has been applied.

Suitable fatty acids include the alkali salts of a C₈-C₂₄ fatty acid. Such alkali salts include the metal fully saturated salts like sodium, potassium and/or lithium salts as well as the ammonium and/or alkylammonium salts of fatty acids, preferably the sodium salt. Preferred fatty acids for use herein contain from 8 to 22, preferably from 8 to 20 and more preferably from 8 to 18 carbon atoms. Suitable fatty acids may be selected from caprylic acid, capric acid, lauric acid, myristic acid, palmitic acid, stearic acid, oleic acid, and mixtures of fatty acids suitably hardened, derived from natural sources such as plant or animal esters (e.g., palm oil, olive oil, coconut oil, soybean oil, castor oil, tallow, ground oil, whale and fish oils and/or babassu oil. For example coconut fatty acid is commercially available from KLK OLEA under the name PALMERAB1211.

Typically, the liquid hard surface cleaning composition may comprise up to 5.0% by weight of the total composition of said fatty acid, preferably from 0.002% to 5%, more preferably from 0.003% to 3% and most preferably from 0.005% to 1% by weight of the total composition of said fatty acid.

Branched fatty alcohol: The liquid hard surface cleaning composition may comprise a branched fatty alcohol, particularly as suds suppressors. Suitable branched fatty alcohols include the 2-alkyl alkanols having an alkyl chain comprising from 6 to 16, preferably from 7 to 13, more preferably from 8 to 12, most preferably from 8 to 10 carbon atoms and a terminal hydroxy group, said alkyl chain being substituted in the a position (i.e., position number 2) by an alkyl chain comprising from 1 to 10, preferably from 2 to 8 and more preferably 4 to 6 carbon atoms. Such suitable compounds are commercially available, for instance, as the Isofol® series such as Isofol® 12 (2-butyl octanol) or Isofol® 16 (2-hexyl decanol) commercially available from Sasol Typically, the liquid hard surface cleaning composition may comprise up to 5.0% by weight of the total composition of said branched fatty alcohol, preferably from 0.002% to 5%, more preferably from 0.003% to 3% and most preferably from 0.005% to 1%.

Solvent: The liquid hard surface cleaning compositions preferably comprises a solvent. Suitable solvents may be selected from the group consisting of: ethers and diethers having from 4 to 14 carbon atoms; glycols or alkoxylated glycols; alkoxylated aromatic alcohols; aromatic alcohols; alkoxylated aliphatic alcohols; aliphatic alcohols; C₈-C₁₄ alkyl and cycloalkyl hydrocarbons and halohydrocarbons; C₆-C₁₆ glycol ethers; terpenes; and mixtures thereof. Typically, the liquid hard surface cleaning composition may comprise up to 10.0% by weight of the total composition of said solvent, preferably from 0.01% to 10%, more preferably from 0.02% to 6% and most preferably from 0.04% to 4%.

Perfumes: The liquid hard surface cleaning compositions preferably comprise a perfume. Suitable perfumes provide an olfactory aesthetic benefit and/or mask any “chemical” odour that the product may have.

Other optional ingredients: The liquid hard surface cleaning compositions may comprise a variety of other optional ingredients depending on the technical benefit aimed for and the surface treated. Suitable optional ingredients for use herein include builders, other polymers, buffers, bactericides, hydrotropes, colorants, stabilizers, radical scavengers, abrasives, soil suspenders, brighteners, anti-dusting agents, dispersants, dye transfer inhibitors, pigments, silicones and/or dyes.

### Pre-Moistened Wipe

The cleaning composition of the present application may be used for a pre-moistened cleaning wipe. If the cleaning wipe is pre-moistened, it is pre-moistened with a cleaning composition, as described in further detail above, which provides for cleaning of the target surface, such as a floor, but yet does not require a post-cleaning rinsing operation.

The pre-moistened cleaning wipe used in conjunction with this cleaning composition may comprise natural or synthetic fibers. The fibers may be hydrophillic, hydrophobic or a combination thereof, provided that the cleaning wipe is generally absorbent to hold, and express upon demand, the above described cleaning composition. In one embodiment, the cleaning wipe may comprise at least 50 weight percent or at least 70 weight percent cellulose fibers, such as air laid SSK fibers. If desired, the cleaning wipe may comprise plural layers to provide for scrubbing, liquid storage, and other particularized tasks for the cleaning operation.

The cleaning wipe may be loaded with at least 1, 1.5 or 2 grams of the cleaning composition, as described above, per gram of dry substrate, but typically not more than 5 grams per gram.

Optionally, the pre-moistened cleaning wipe may further comprise a scrubbing strip. A scrubbing strip is a portion of the cleaning wipe which provides for more aggressive cleaning of the target surface. A suitable scrubbing strip may comprise a polyolefinic film, such as LDPE, and have outwardly extending perforations, etc. The scrubbing strip may be made and used according to commonly assigned U.S. Pat. Nos. 8,250,700; 8,407,848; D551,409 S and/or D614,408 S. A suitable pre-moistened cleaning wipe maybe made according to the teachings of commonly assigned U.S. Pat. No. 6,716,805; D614,408; D629,211 and/or D652,633.

### Cleaning Implement

The cleaning composition according to the present application may be used with a cleaning implement. The cleaning implement may comprise a plastic head for holding a disposable cleaning wipe and an elongate handle articulably connected thereto. The wipe may comprise natural or synthetic fibers which may be hydrophilic, hydrophobic or a combination thereof. The handle may comprise a metal or plastic tube or solid rod.

The head may have a downwardly facing surface, to which a disposable dry cleaning wipe may be attached. The downwardly facing surface may be generally flat, or slightly convex. The head may further have an upwardly facing surface. The upwardly facing surface may have a universal joint to facilitate connection of the elongate handle to the head.

A hook and loop system may be used to attach a cleaning wipe directly to the bottom of the head. Alternatively, the upwardly facing surface may further comprise a mechanism, such as resilient grippers, for removably attaching the cleaning sheet to the implement. If grippers are used with the cleaning implement, the grippers may be made according to commonly assigned U.S. Pat. Nos. 6,305,046; 6,484,346; 6,651,290 and/or D487,173.

The cleaning implement may further comprise a reservoir for storage of the cleaning composition, a described in further detail above. The reservoir may be replaced when the cleaning composition is depleted and/or refilled as desired. The reservoir may be disposed on the head or the handle of the cleaning implement. The neck of the reservoir may be offset per commonly assigned U.S. Pat. No. 6,390,335.

The cleaning composition, as described in further detail above, may be sprayed onto the target surface using a pump, using a gravity drain system or applied with steam. A suitable cleaning implement may be made according to the teachings of commonly assigned U.S. Pat. Nos. 5,888,006; 5,960,508; 5,988,920; 6,045,622; 6,101,661; 6,142,750; 6,579,023; 6,601,261; 6,722,806; 6,766,552; D477,701 and/or D487,174. A steam implement may be made according to the teachings of jointly assigned 2013/0319463.

### Method of Cleaning a Surface:

Disposable premoistened wipes and cleaning implements that include liquid hard surface cleaning compositions comprising an ethoxylated alkoxylated nonionic surfactant and at least one other detersive surfactant, especially the compositions of the present application, are suitable for cleaning household surfaces. In particular, disposable premoistened wipes and cleaning implements that include such compositions are particularly useful for improving surface shine, especially of hard surfaces. Suitable detersive surfactants can be selected from the group consisting of: anionic surfactant, nonionic surfactant, and mixtures thereof.

For general cleaning, especially of floors, a preferred method of cleaning comprises the steps of:
a) contacting a hard surface with a disposable premoistened wipe comprising a liquid hard surface cleaning composition comprising an ethoxylated alkoxylated nonionic surfactant, and
b) optionally, allowing the cleaning composition to dry or, in some embodiments, removing the cleaning composition from the hard surface by rinsing the hard surface with water and/or wiping the hard surface with an appropriate instrument, e.g., a sponge, a paper or cloth towel and the like.

In another embodiment for general cleaning, especially of floors, the preferred method of cleaning comprises the steps of:
(a) spraying the hard surface with a liquid hard surface cleaning composition comprising an ethoxylated alkoxylated nonionic surfactant and
(b) removing the cleaning composition from the hard surface with a disposable dry cleaning wipe.

### Methods:

### A) pH Measurement:

The pH is measured on the neat composition, at 25° C., using a Sartarius PT-10P pH meter with gel-filled probe (such as the Toledo probe, part number 52 000 100), calibrated according to the instructions manual.

### B) Shine Test for Floor Cleaning:

The shine test is done with soil mixture which consists of a mixture of consumer relevant soils such as oil, particulates, pet hair, sugar etc. The black glossy ceramic tiles are soiled with the soil mixture and cleaned with the liquid hard surface cleaning composition(s) and, after letting them dry, results are analyzed by using grading scale described below.

| | and PSU Scale |
|---|---|
| Grading in absolute scale: | (average of 3 graders): |
| 0 = as new/no streaks and/or film | 0 = I see no difference |
| 1 = very slight streaks and/or film | 1 = I think there is difference |
| 2 = slight streaks and/or film | 2 = I am sure there is a slight |
| | difference |
| 3 = slight to moderate streaks and/or film | 3 = I am sure there is a |
| | difference |
| 4 = moderate streaks and/or film | 4 = I am sure there is a big |
| | difference |
| 5 = moderate/heavy streaks and/or film | |
| 6 = heavy streaks and/or film | |

### C) Drying Time:

While performing the Shine test under soiled conditions, in a controlled temperature and humidity room at 20° C. and a relative humidity of 40% the time taken for the tiles to completely dry is measured.

### D) Turbidity (NTU):

The turbidity (measured in NTU: Nephelometric Turbidity Units) is measured using a Hach 2100P turbidity meter calibrated according to the procedure provided by the manufacture. The sample vials are filled with 15 ml of representative sample and capped and cleaned according to the operating instructions. If necessary, the samples are degassed to remove any bubbles either by applying a vacuum or using an ultrasonic bath (see operating manual for procedure). The turbidity is measured using the automatic range selection.

### EXAMPLES

Example 1 was prepared as a comparative formulation. Examples 2, 3 and 4 were prepared as compositions of the present invention.

Comparative example 1 comprised 0.04 wt % of an amine oxide, as a non-ionic surfactant, in addition to 0.005% of HLAS as anionic surfactant. Example 2 was formulated with the same ingredients, at the same level as example 1, except that 0.003% of an ethoxylated alkoxylated non-ionic surfactant of formula I (Plurafac LF7319, having a wetting effect of 100) was added. As such, the ratio of ethoxylated alkoxylated nonionic surfactant to additional nonionic surfactant for example 2 is 0.075. Example 3 was formulated with the same ingredients, at the same level as example 1, except that 0.009% of an ethoxylated alkoxylated non-ionic surfactant of formula I (Plurafac LF7319, having a wetting effect of 100) was added. As such, the ratio of ethoxylated alkoxylated nonionic surfactant to additional nonionic surfactant for example 3 is 0.225. Example 4 was formulated with the same ingredients, at the same level as example 1, except that 0.018% of an ethoxylated alkoxylated non-ionic surfactant of formula I (Plurafac LF7319, having a wetting effect of 100) was added. As such, the ratio of ethoxylated alkoxylated nonionic surfactant to additional nonionic surfactant for example 4 is 0.45.

| | EX 1 | Ex 2 | Ex 3 | Ex 4 |
|---|---|---|---|---|
| | wt. % | wt. % | wt. % | wt. % |
| Ratio of Plurafac to AO | 0 | 0.075 | 0.225 | 0.45 |
| NaLAS¹ | 0.005 | 0.005 | 0.005 | 0.005 |
| C12-14 Amine Oxide² | 0.04 | 0.04 | 0.04 | 0.04 |
| Plurafac LF7319³ | 0.0 | 0.003 | 0.009 | 0.018 |
| Dowanol PnB/ | 0.5 | 0.5 | 0.5 | 0.5 |
| Propylene Glycol Butyl | | | | |
| Ether | | | | |
| Bardac 2250 | 0.02 | 0.02 | 0.02 | 0.02 |
| Dow Corning 1410 | 0.002 | 0.002 | 0.002 | 0.002 |
| Perfume | 0.03 | 0.03 | 0.03 | 0.03 |
| pH | 6.5 | 6.5 | 6.5 | 6.5 |
| Minors and Water | to 100% | to 100% | to 100% | to 100% |

* Comparative
¹sodium linear alkylbenzene sulphonate commercially available from Huntsman
²amine oxide nonionic surfactant commercially available from Huntsman
³commercially available from BASF

Examples 1 to 4 were evaluated for shine benefit under soiled conditions, using the procedure described above (Shine test for floor cleaning). The results are given below. For the absolute grading, a lower score indicates improved shine, as described in the test method. For the PSU grading, Example 1 was used as the reference. For the PSU grading, a higher score indicates improved shine. Examples 1 to 4 were also evaluated for drying time, using the method described above (Drying Time), and the results are also given in the table below:

TABLE 1

| | Shine result: | | |
|---|---|---|---|
| | Absolute | Shine result: | |
| | grading | PSU grading | Drying time |
| Example 1 (Comparative) | 5.1 | Reference | 124 s |
| Example 2 (of invention) | 4.9 | +0.5 | 109 s |
| Example 3 (of invention) | 4.4 | +1.75 | 106 s |
| Example 4 (of invention) | 5.6 | −1.25 | 91 s |

As can be seen in table 1, the addition of an ethoxylated alkoxylated non-ionic surfactant to the hard surface cleaning composition results in both improved shine, in addition to a reduction in drying time. When the ethoxylated alkoxylated nonionic surfactant is added, such that the ratio of ethoxylated alkoxylated nonionic surfactant to additional nonionic surfactant is between 0.035 to 0.4, the improvement in shine is particularly noticeable.

The following ethoxylated alkoxylated non-ionic surfactants have been found to provide improvements in shine: Plurafac LF 132, Plurafac LF 305, Plurafac LF 7319, Plurafac LF 224, Plurafac LF 120, Plurafac LF 131, Plurafac LF 220, Plurafac LF 221, Plurafac LF 223, Plurafac LF 300, Plurafac LF 303, Plurafac LF 400, Plurafac LF 404, Plurafac LF 431, Plurafac LF 500, Plurafac LF 900, Dowfax 63N10, Dowfax 20A612, Dowfax 20A42. As such, they are particularly suitable for use in liquid hard surface cleaning compositions, including the compositions exemplified in examples A to I below:

| | A | B | C | D | E | F | G | H | I |
|---|---|---|---|---|---|---|---|---|---|
| | wt % | wt % | wt % | wt % | wt % | wt % | wt % | wt % | wt % |
| C9/11 EO8⁴ | 0.04 | — | — | — | — | — | 0.04 | 0.04 | 0.04 |
| NaLAS⁵ | 0.005 | 0.005 | 0.005 | 0.005 | | 0.005 | 0.005 | 0.005 | 0.005 |
| NaPS⁶ | — | — | — | 0.005 | 0.005 | — | | — | — |
| C12-14 Amine | 0.0 | 0.04 | 0.04 | 0.04 | 0.04 | 0.04 | 0.04 | 0.06 | 0.06 |
| Oxide⁷ | | | | | | | | | |
| ethoxylated | 0.003 | 0.003 | 0.003 | 0.009 | 0.009 | 0.009 | 0.009 | 0.009 | 0.018 |
| alkoxylated non- | | | | | | | | | |
| ionic surfactant | | | | | | | | | |
| Lupasol SK | 0.04 | 0.04 | | | 0.04 | 0.04 | 0.04 | | |
| Polyethyleneimine⁸ | | | | | | | | | |
| Mirapol 300⁹ | | | 0.02 | 0.02 | | | | 0.02 | |
| Na₂CO₃ | — | — | | | | | | | |
| Caustic | −0.00075 | −0.00275 | | | — | | | | |
| Propylene glycol | | 0.05 | 0.07 | 0.05 | 0.05 | — | 0.05 | | 0.05 |
| n-butyl etherl¹⁰ | | | | | | | | | |
| Propylene glycol | 0.05- | — | — | — | — | — | | −0.05 | — |
| methyl ether¹¹ | | | | | | | | | |
| GLDA¹² | — | — | — | — | 0.05 | — | — | — | — |
| IPA¹³ | — | — | — | — | — | 0.5 | — | — | — |
| n-BPP¹⁴ | — | — | — | — | 0.5 | — | — | — | — |
| n-BP¹⁵ | — | — | — | 0.5 | 2.0 | — | — | — | — |
| Minors and Water | up to | up to | up to | up to | up to | up to | up to | up to | up to |
| | 100% | 100% | 100% | 100% | 100% | 100% | 100% | 100% | 100% |
| pH | 9.0 | 9.5 | 6.5 | 6.5 | 6.5 | 6.5 | 6.5 | 6.5 | 6.5 |

⁴nonionic surfactant commercially available from Shell.
⁵sodium linear alkylbenzene sulphonate commercially available from Huntsman
⁶sodium paraffin sulfonate commercially available from ICS
⁷amine oxide nonionic surfactant commercially available from Huntsman
⁸branched spherical polymeric amine commercially available from BASF
⁹cationic polymer commercially available from Rhodia, Inc
¹⁰commercially available from DOW Chemicals as Dowanol PnB
¹¹commercially available from DOW Chemicals as Dowanol Pm
¹²Glutamic acid diacetic acid chelating agent commercially available from AkzoNobel
¹³isopropanol, commercially available from JT Baker
¹⁴butoxy propoxy propanol, commercially available from Dow Chemicals
¹⁵normal butoxy propanol commercially available from Dow Chemicals

The dimensions and other values disclosed herein are not to be understood as being strictly limited to the exact numerical values recited. Instead, unless otherwise specified, each such value is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A disposable premoistened wipe for cleaning hard surfaces comprising:
a substrate and
a cleaning composition comprising:
(a) an ethoxylated alkoxylated nonionic surfactant,
(b) an additional nonionic surfactant selected from the group consisting of: an alkyl ethoxylated alcohol, alkyl polyglycosides, amine oxide, and mixture thereof, and
(c) an anionic surfactant,
wherein said substrate is impregnated with said cleaning composition.

2. The disposable premoistened wipe according to claim 1, wherein the composition comprises from 0.002% to 5%, more preferably from 0.003% to 3%, most preferably from 0.005% to 1% of the ethoxylated alkoxylated nonionic surfactant.

3. The disposable premoistened wipe according to claim 1, wherein the ethoxylated alkoxylated nonionic surfactant is selected from the group consisting of: an alkyl ethoxy alkoxy alcohol, an esterified alkyl alkoxylated surfactant, a polyoxyalkylene block copolymer, and combinations thereof.

4. The disposable premoistened wipe according to claim 1, wherein the ethoxylated alkoxylated nonionic surfactant is:
(a) an esterified alkyl alkoxylated surfactant of formula (I): 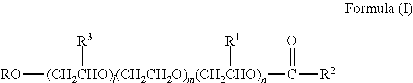
wherein:
R is a branched or unbranched alkyl radical having 8 to 16 carbon atoms;
R³, R¹ independently of one another, are hydrogen or a branched or unbranched alkyl radical having 1 to 5 carbon atoms;
R² is an unbranched alkyl radical having 5 to 17 carbon atoms;
l, n independently of one another, are a number from 1 to 5; and
m is a number from 8 to 50;
(b) an alkyl ethoxy alkoxy alcohol of formula (II): 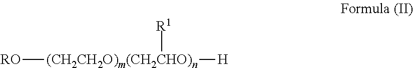
wherein:
R is a branched or unbranched alkyl radical having 8 to 16 carbon atoms;
R¹ is a branched or unbranched alkyl radical having 1 to 5 carbon atoms;
n is a number from 1 to 10; and
m is a number from 6 to 35.
(c) and mixtures thereof.

5. The disposable premoistened wipe according to claim 1, wherein the ethoxylated alkoxylated nonionic surfactant provides a wetting effect of from 15 to 350, more preferably from 60 to 200, even more preferably from 75 to 150, as measured according to EN 1772, using 1 g/l of the ethoxylated alkoxylated nonionic surfactant in distilled water, at 23° C., with 2 g soda/l.

6. The disposable premoistened wipe according to claim 1, wherein the surfactants, excluding the ethoxylated alkoxylated nonionic surfactant, have an overall HLB value of from 6 to 36, preferably from 8 to 26, more preferably from 10 to 15.

7. The disposable premoistened wipe according to claim 1, wherein the hard surface cleaning composition comprises:
(a) an anionic surfactant selected from the group consisting of: an alkyl sulphate, an alkyl alkoxylated sulphate, a sulphonic acid or sulphonate surfactant, and mixtures thereof;
(b) a nonionic surfactant selected from the group consisting of: alkyl alkoxylates, alkyl phenol alkoxylates, semipolar nonionics, and mixtures thereof.

8. The disposable premoistened wipe according to claim 1, further comprising at least one amine oxide surfactant.

9. The disposable premoistened wipe according to claim 1, wherein the composition has a pH of from 5.0 to 12, more preferably from 5.0 to 11.5, even more preferably from 6.0 to 11.3, most preferably 6.0 to 11.

10. The disposable premoistened wipe according to claim 1, wherein the viscosity of the composition is from 0.1 cps to 650 cps, more preferably of from 0.5 cps to 450 cps, more preferably from 1 cps to 300 cps and most preferably from 1 cps to 250 cps when measured at 20° C. with a AD1000 Advanced Rheometer from Atlas® shear rate 10 s-1 with a coned spindle of 40 mm with a cone angle 2° and a truncation of ±60 p.m.

11. The disposable premoistened wipe according to claim 1, wherein the ratio of ethoxylated alkoxylated nonionic surfactant to additional nonionic surfactant is between about 0.035 and about 0.4.

12. A method of cleaning a hard surface comprising contacting a hard surface with the disposable premoistened wipe according to claim 1.

13. A cleaning implement for cleaning hard surfaces comprising:
(a) a disposable dry cleaning wipe; and
(b) a reservoir filled with a cleaning composition comprising:
(i) an ethoxylated alkoxylated nonionic surfactant,
(ii) an additional nonionic surfactant selected from the group consisting of: an alkyl ethoxylated alcohol, alkyl polyglycosides, amine oxide, and mixture thereof, and
(iii) an anionic surfactant.

14. The cleaning implement according to claim 13, wherein the composition comprises from 0.002% to 5%, more preferably from 0.003% to 3%, most preferably from 0.005% to 1% of the ethoxylated alkoxylated nonionic surfactant.

15. The cleaning implement according to claim 13, wherein the ethoxylated alkoxylated nonionic surfactant is selected from the group consisting of: an alkyl ethoxy alkoxy alcohol, an esterified alkyl alkoxylated surfactant, a polyoxyalkylene block copolymer, and combinations thereof.

16. The cleaning implement according to claim 13, wherein the ethoxylated alkoxylated nonionic surfactant is:
(a) an esterified alkyl alkoxylated surfactant of formula (I): 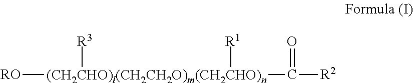
wherein:
R is a branched or unbranched alkyl radical having 8 to 16 carbon atoms;
R³, R¹ independently of one another, are hydrogen or a branched or unbranched alkyl radical having 1 to 5 carbon atoms;
R² is an unbranched alkyl radical having 5 to 17 carbon atoms;
l, n independently of one another, are a number from 1 to 5; and
m is a number from 8 to 50;
(b) an alkyl ethoxy alkoxy alcohol of formula (II): 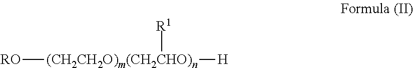
wherein:
R is a branched or unbranched alkyl radical having 8 to 16 carbon atoms;
R¹ is a branched or unbranched alkyl radical having 1 to 5 carbon atoms;
n is a number from 1 to 10; and
m is a number from 6 to 35.
(c) and mixtures thereof.

17. The cleaning implement according to claim 13, wherein the surfactants, excluding the ethoxylated alkoxylated nonionic surfactant, have an overall HLB value of from 6 to 36, preferably from 8 to 26, more preferably from 10 to 15.

18. The cleaning implement according to claim 13, wherein the hard surface cleaning composition comprises:
(c) an anionic surfactant selected from the group consisting of: an alkyl sulphate, an alkyl alkoxylated sulphate, a sulphonic acid or sulphonate surfactant, and mixtures thereof;
(d) a nonionic surfactant selected from the group consisting of: alkyl alkoxylates, alkyl phenol alkoxylates, semipolar nonionics, and mixtures thereof.

19. The cleaning implement according to claim 13, further comprising at least one amine oxide surfactant.

20. The cleaning implement according to claim 13, wherein the composition has a pH of from 5.0 to 12, more preferably from 5.0 to 11.5, even more preferably from 6.0 to 11.3, most preferably 6.0 to 11.

21. The cleaning implement according to claim 13, wherein the viscosity of the composition is from 0.1 cps to 650 cps, more preferably of from 0.5 cps to 450 cps, more preferably from 1 cps to 300 cps and most preferably from 1 cps to 250 cps when measured at 20° C. with a AD1000 Advanced Rheometer from Atlas® shear rate 10 s-1 with a coned spindle of 40 mm with a cone angle 2° and a truncation of ±60 μm.

22. The cleaning implement according to claim 13, wherein the ratio of ethoxylated alkoxylated nonionic surfactant to additional nonionic surfactant is between about 0.035 and about 0.4.

23. A method of cleaning a hard surface with the cleaning implement according to claim 13 comprising:
(a) spraying the hard surface with the cleaning composition and
(b) removing the cleaning composition from the hard surface with the disposable dry cleaning wipe.
